(19) United States
(12) Patent Application Publication
(10) Pub. No.: US 2020/0107134 A1
(43) Pub. Date: Apr. 2, 2020

(54) ACTUATOR AND PANEL SPEAKER

(71) Applicant: NIDEC SANKYO CORPORATION, Nagano (JP)

(72) Inventors: Akira MORI, Nagano (JP); Kenichi KUWAHARA, Nagano (JP); Tetsuo MOMOSE, Nagano (JP)

(21) Appl. No.: 16/582,057

(22) Filed: Sep. 25, 2019

(30) Foreign Application Priority Data
Sep. 27, 2018 (JP) 2018-181649

(51) Int. Cl. H04R 9/06; H02K 33/18; H04R 9/02; H04R 9/04; H04R 7/18; H04R 1/02

(52) U.S. Cl. CPC H04R 9/06; H02K 33/18; H04R 9/025; H04R 2499/15; H04R 7/18; H04R 1/028; H04R 9/046

(57) ABSTRACT

An actuator includes a movable body in which a first yoke and a second yoke overlay in a first direction both sides of a permanent magnet magnetized in the first direction. A side plate portion of the second yoke faces the first yoke across a coil in a direction intersecting the first direction. The movable body includes a holder to which the outer face of the side plate portion of the second yoke is fixed. Thus, viscoelastic members can be disposed between first flat faces of outer walls of the holder and second flat faces of inner walls of a support body, regardless of the shape of the coil and the shape of the second yoke. Hence, the viscoelastic members may be flat members.

### CROSS REFERENCE TO RELATED APPLICATION

The present application claims priority under 35 U.S.C. § 119 to Japanese Patent Application No. 2018-181649 filed Sep. 27, 2018, the entire content of which is incorporated herein by reference.

### FIELD OF THE INVENTION

At least an embodiment of the present invention relates to an actuator that generates various vibrations and a panel speaker.

### BACKGROUND

An actuator has been proposed to serve as a device that generates vibration by a magnetic drive circuit. The actuator includes a support body holding a cylindrical coil and a movable body supported by the support body via a gelatinous damper member (refer to Japanese Unexamined Patent Application Publication No. 2017-60207). The movable body of such an actuator includes a permanent magnet disposed on the inner side of the coil in the radial direction, a first yoke fixed to one side of the permanent magnet in the axial direction on the inner side of the coil in the radial direction, and a second yoke fixed to the other side of the permanent magnet in the axial direction. The second yoke includes a side plate portion extending to a position facing the first yoke across the coil in a direction intersecting the axial direction, and a gelatinous damper member disposed between the second yoke and the support body that face each other in a direction intersecting the axial direction. The coil has a cylindrical shape. The first yoke, the permanent magnet, and a plate portion of the second yoke fixed to the permanent magnet each has a discoid shape. The side plate portion of the second yoke constitutes a cylindrical body portion. Thus, the gelatinous damper member has an arcuately curved shape and is disposed between the side plate portion (cylindrical body portion) of the second yoke and the arcuate inner wall of the support body.

Viscoelastic members, such as gelatinous damper members, have viscoelasticity. Thus, handling such members in an arcuately curved state is an extremely troublesome task. Thus, the actuator described in Japanese Unexamined Patent Application Publication No. 2017-60207 unfortunately has low productivity.

### SUMMARY

At least an embodiment of the present invention, which has been conceived in view of the issues described above, provides an actuator and a panel speaker, and the actuator allows planar viscoelastic members to be disposed between a movable body and a support body, regardless of the shapes of a coil and yokes.

To solve the issues described above, an actuator according to at least an embodiment of the present invention includes a support body that holds a cylindrical coil wound around an axis extending in a first direction; a movable body supported by the support body via a viscoelastic member; the movable body including a permanent magnet magnetized in the first direction; a first yoke fixed to a one side of the permanent magnet in the first direction inside the coil; a second yoke fixed to another side of the permanent magnet in the first direction and including a side plate portion extending to a position facing the first yoke across the coil in a direction intersecting the first direction; and a holder to which an outer face of the side plate portion is fixed, an outer wall of the holder including first flat faces on both sides in a second direction intersecting the first direction, an inner wall of the support body including second flat faces facing the first flat faces on both sides in the second direction, the viscoelastic member including flat members disposed between the first flat faces and the corresponding second flat faces on both sides in the second direction.

In the movable body according to at least an embodiment of the present invention, the first yoke and the second yoke overlay both sides of the permanent magnet in the first direction, the permanent magnet being magnetized in the first direction. The side plate portion of the second yoke faces the first yoke across the coil in a direction intersecting the first direction. Thus, when electrical power is applied to the coil, the movable body is driven in the first direction. The movable body includes the holder to which the outer face of the side plate portion of the second yoke is fixed. Thus, the viscoelastic members can be disposed between the first flat faces of the outer walls of the holder and the second flat faces of the inner walls of the support body, regardless of the shapes of the coil and the second yoke. Hence, the viscoelastic members may be flat members. This leads to advantages such as ready handling of the viscoelastic members during assembling of the actuator.

In at least an embodiment of the present invention, the side plate portion may include a cylindrical body portion facing the first yoke across the coil along an entire circumference around the axis.

In at least an embodiment of the present invention, the coil may have a cylindrical shape; the first yoke, the permanent magnet, and a plate portion of the second yoke fixed to the permanent magnet may have discoid shapes; and the cylindrical body portion may have a cylindrical shape.

In at least an embodiment of the present invention, the outer wall of the holder may further include first flat faces on both sides in a third direction intersecting the first direction and the second direction; the inner wall of the support body may further include second flat faces facing the first flat faces on both sides in the third direction; and the viscoelastic member may include flat members disposed between the first flat faces and the corresponding second flat faces on both sides in the second direction and both sides in the third direction.

In at least an embodiment of the present invention, a portion of the outer wall disposed between the first flat faces adjacent to each other around the axis may include a convex face curved along the first direction and protruding toward the support body.

In at least an embodiment of the present invention, the center of gravity of the movable body and the center of the viscoelastic member in the first direction may positionally coincide with each other in the first direction. Such an embodiment is advantageous in that the movable body does not readily tilt.

In at least an embodiment of the present invention, the center of the first yoke in the first direction and the center of the viscoelastic member in the first direction may positionally coincide with each other in the first yoke. Such an embodiment is advantageous in that the movable body does not readily tilt during driving of the movable body.

In at least an embodiment of the present invention, the center of the first yoke in the first direction, the center of the viscoelastic member in the first direction, and the center of gravity of the movable body may positionally coincide with each other in the first direction. Such an embodiment is advantageous in that the movable body does not readily tilt during driving of the movable body.

In at least an embodiment of the present invention, a through-hole may penetrate the movable body at the center of the movable body in the first direction. According to this embodiment, the first yoke, the permanent magnet, and the second yoke may be assembled on the basis of the through-hole.

The actuator according to at least an embodiment of the present invention may be used in a panel speaker or the like. In the panel speaker, an end on one side of the support body in the first direction may be fixed to a panel member. In the panel speaker according to this embodiment, one end of the support body in the first direction may be fixed to the panel member. Since no chassis or the like is required for fixing the actuator to the back face of the panel member, the panel speaker can have a small thickness.

In at least an embodiment of the present invention, the panel member, for example, may be a display panel.

In the movable body according to at least an embodiment of the present invention, the first yoke and the second yoke overlay both sides of the permanent magnet in the first direction, the permanent magnet being magnetized in the first direction. The side plate portion of the second yoke faces the first yoke across the coil in a direction intersecting the first direction. Thus, when electrical power is applied to the coil, the movable body is driven in the first direction. The movable body includes the holder to which the outer face of the side plate portion of the second yoke is fixed. Thus, the viscoelastic member can be disposed between the first flat faces of the outer walls of the holder and the second flat faces of the inner walls of the support body, regardless of the shapes of the coil and the second yoke. Hence, the viscoelastic member may be flat members. This leads to advantages such as ready handling of the viscoelastic member during assembling of the actuator.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view illustrating an actuator to at least an embodiment of the present invention;

FIG. 2 is an exploded perspective view of the actuator illustrated in FIG. 1 in which a cover, an outer cover, and a seal member of a support body are removed;

FIG. 3 is a cross-sectional view of the actuator taken along the first and second directions in FIG. 1;

FIG. 4 is a cross-sectional view of the actuator taken along the first and third directions in FIG. 1;

FIG. 5 is an exploded perspective view of the actuator illustrated in FIG. 1 in which viscoelastic members, etc., are removed;

FIG. 6 is an exploded perspective view of the actuator illustrated in FIG. 1 in which the support body and a movable body are separated;

FIG. 7 illustrates a coil bobbin and a coil of the support body illustrated in FIG. 6;

FIG. 8 illustrates the configuration of the bottom face of a base illustrated in FIG. 6;

FIG. 9 is an exploded perspective view of the movable body illustrated in FIG. 2;

FIG. 10 illustrates a stopper mechanism disposed between the support body and the movable body illustrated in FIG. 2, etc.; and

FIG. 11 illustrates a panel speaker including the actuator illustrated in FIG. 1.

### DETAILED DESCRIPTION

Embodiments of the present invention will be described with reference to the drawings. In the following description, three directions intersecting each other will be referred to as a first direction Z, a second direction X, and a third direction Y. The first direction Z, the second direction X, and the third direction Y are orthogonal to each other. One side in the first direction Z is denoted as Z1, the other side in the first direction Z is denoted as Z2. One side in the second direction X is denoted as X1, and the other side in the second direction X is denoted X2. One side in the third direction Y is denoted as Y1, and the other side in the third direction Y is denoted as Y2.

### Overall Configuration

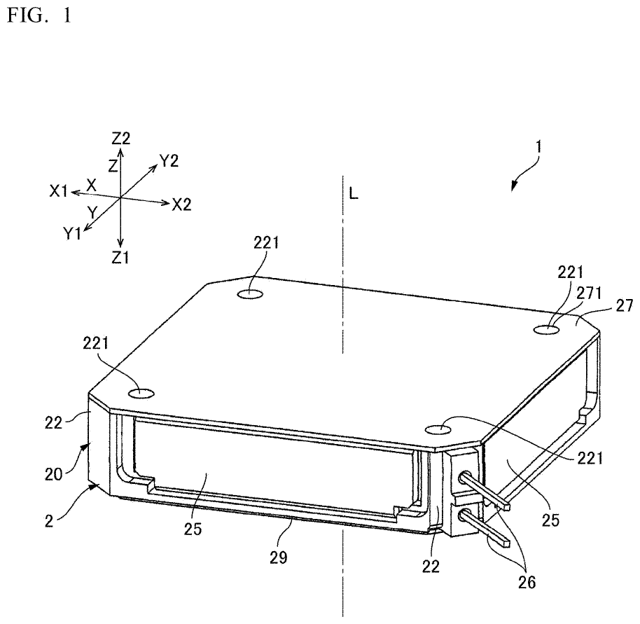

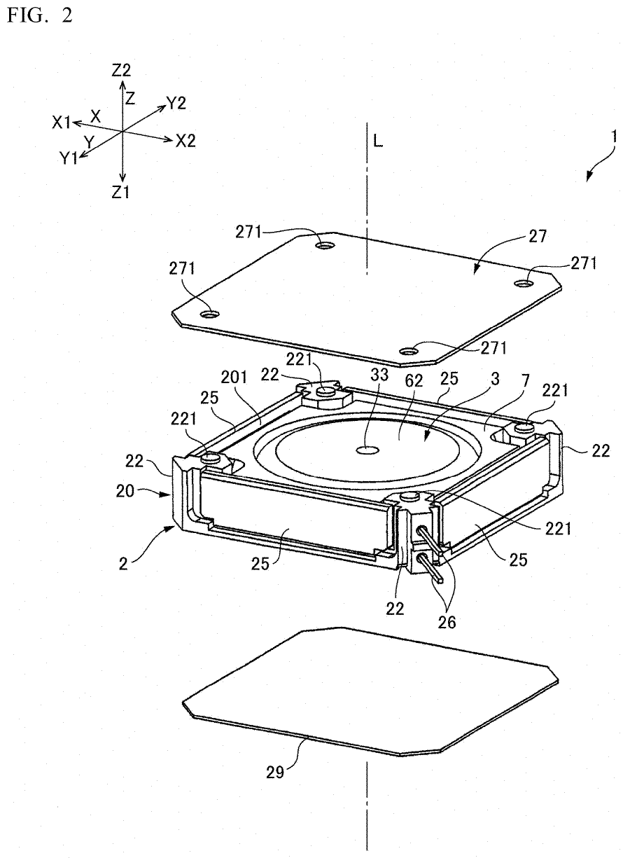

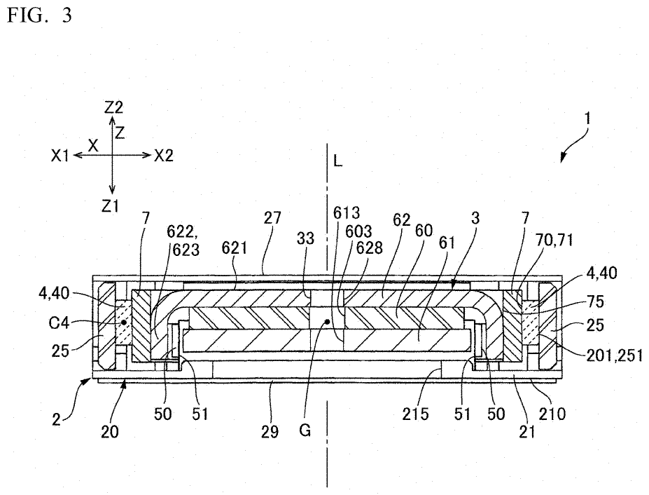

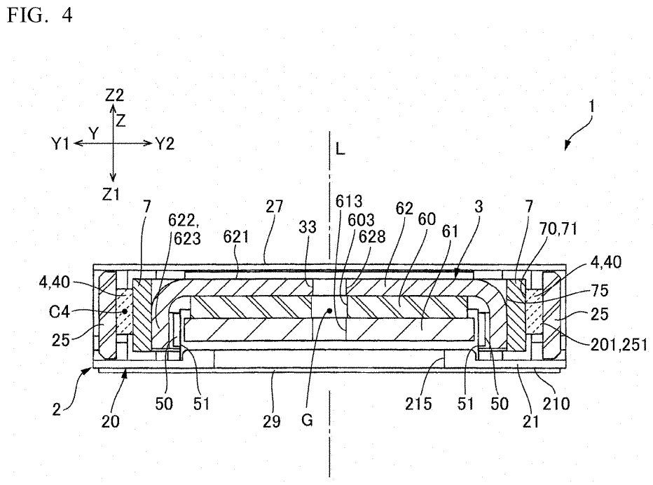

FIG. 1 is a perspective view illustrating an actuator 1 according to at least an embodiment of the present invention is applied. FIG. 2 is an exploded perspective view of the actuator 1 illustrated in FIG. 1 in which a cover 27 and a seal member 29 of a support body 2 are removed. FIG. 3 is a cross-sectional view of the actuator 1 taken along the first direction Z and the second direction X in FIG. 1. FIG. 4 is a cross-sectional view of the actuator 1 taken along the first direction Z and the third direction Y in FIG. 1.

As illustrated in FIG. 1, FIG. 2, FIG. 3, and FIG. 4, the actuator 1 according to this embodiment has a flat substantially cuboid shape in which the length in the first direction Z is smaller than the respective lengths in the second direction X and the third direction Y. The actuator 1 includes a support body 2 and a movable body 3. The support body 2 holds a cylindrical coil 50 wound around an axis L extending in the first direction Z. The movable body 3 is supported on the support body 2 via viscoelastic members 4. The movable body 3 holds a permanent magnet 60, etc., that constitute a magnetic drive circuit 5 together with the coil 50. Thus, the movable body 3 can be vibrated in the first direction Z by a drive current fed to the coil 50 from an external device via a terminal 26.

### Configuration of Support Body 2

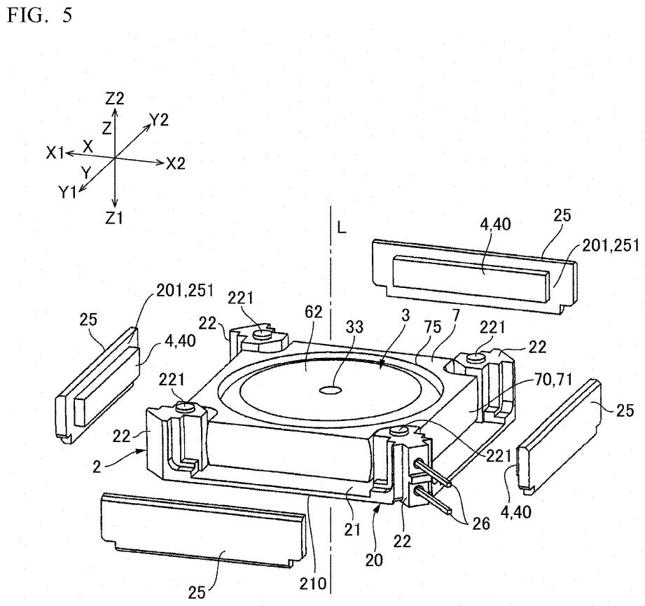

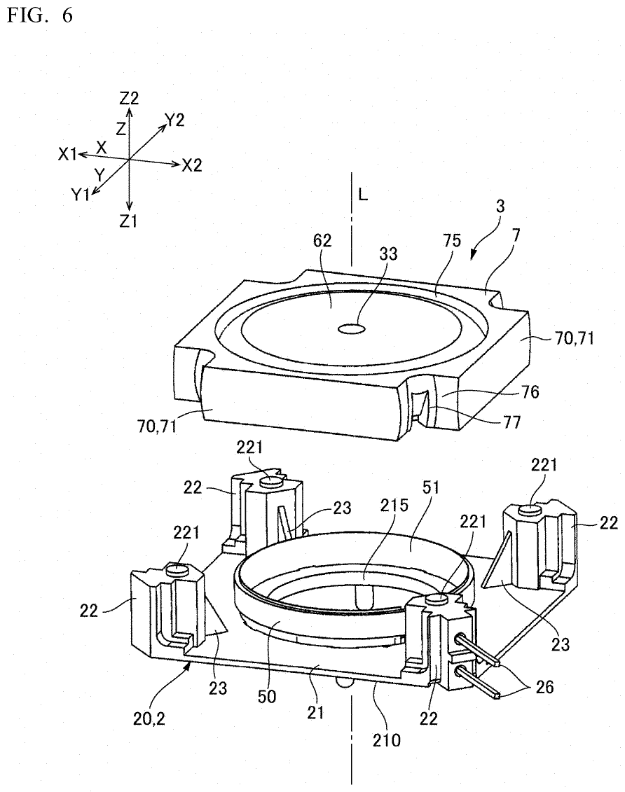

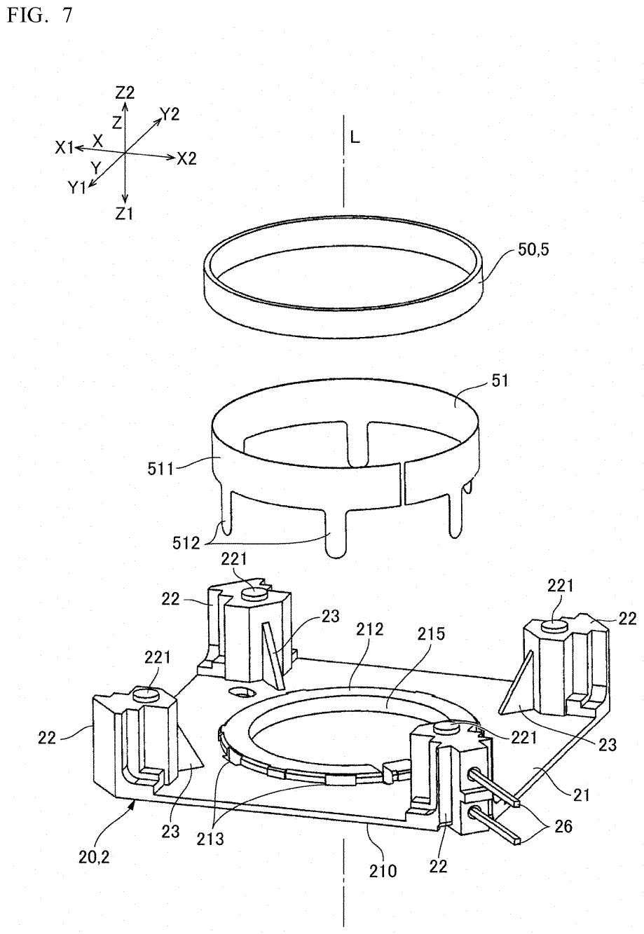

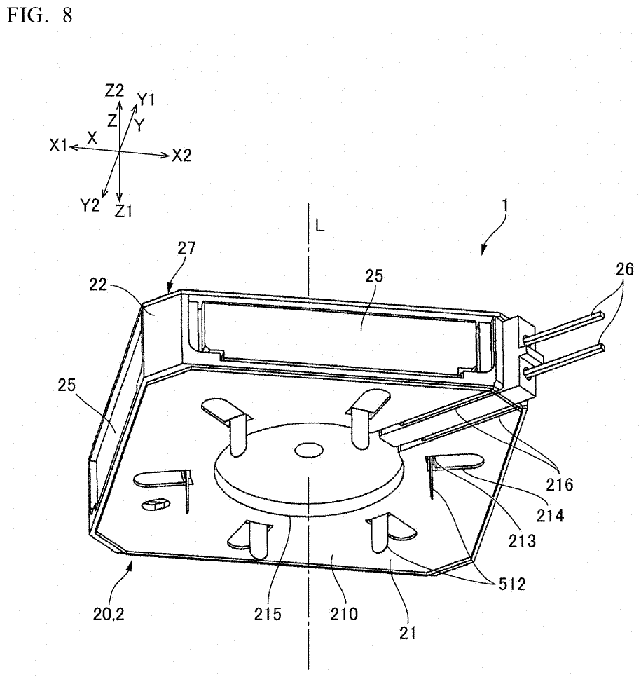

FIG. 5 is an exploded perspective view of the actuator 1 illustrated in FIG. 1 in which the viscoelastic members 4, etc., are removed. FIG. 6 is an exploded perspective view of the actuator 1 illustrated in FIG. 1 in which the support body 2 and the movable body 3 are separated. FIG. 7 illustrates a coil bobbin 51 and the coil 50 of the support body 2 illustrated in FIG. 6. FIG. 8 illustrates the configuration of a bottom face 210 of a base 20 illustrated in FIG. 6. FIG. 8 is a perspective view of a bottom plate portion 21 of the base 20 from the side Z1 in the first direction Z with the seal member 29 omitted.

As illustrated in FIG. 2, FIG. 5, FIG. 6, and FIG. 7, the support body 2 includes a base 20 having a flat quadrangular shape. The base 20 is composed of, for example, resin. The base 20 has a quadrangular bottom plate portion 21 and columnar portions 22 projecting from the four corners of the bottom plate portion 21 to the side Z2 in the first direction Z. The bottom plate portion 21 and the columnar portions 22 are connected by triangular plate portions 23.

The ends on the side Z2 of the four columnar portions 22 in the first direction Z are provided with protrusions 221. Two terminals 26 are fixed to one of the columnar portions 22 disposed at the four corners of the bottom plate portion 21. The two ends of the coil 50 are connected with the corresponding terminals 26. A circular hole 215 is formed at the center of the bottom plate portion 21. An annular protrusion 212 is formed around the hole 215 and protrudes to the side Z2 in the first direction Z. Several slits 213 penetrating the bottom plate portion 21 in the first direction Z are disposed around the protrusion 212.

A thin-plate-like or sheet-like seal member 29 is fixed to the bottom plate portion 21 of the base 20 by an adhesive agent or the like on the side Z1 in the first direction Z. The side Z2 of the base 20 in the first direction Z is covered with a cover 27. The cover 27 is a thin plate or a sheet having holes 271 that receive the protrusions 221 of the columnar portions 22. Support plates 25 are fixed to the base 20 so as to close the space between the columnar portions 22. The inner faces of the support plates 25 on both sides in the second direction X and both sides in the third direction Y constitute an inner wall 201 of the support body 2.

In this embodiment, the coil 50 is mounted on the support body 2 by fixing a coil bobbin 51 having an annular portion 511 extending around the axis L to the base 20, as illustrated in FIG. 6 and FIG. 7. The coil bobbin 51 is formed by processing a nonmagnetic metal plate. The belt-like portion of the metal plate is arcuately bent to form the annular portion 511. The outer circumferential face of the annular portion 511 holds the cylindrical coil 50. The coil bobbin 51 further includes claw-like tabs 512 protruding from the annular portion 511 to the side Z1 in the first direction Z. The coil bobbin 51 is fixed to the base 20 while the tabs 512 are fitted in the slits 213.

In the present embodiment, recesses 214 connected with the corresponding slits 213 are formed in the surface (bottom face 210) of the bottom plate portion 21 of the base 20 on the side Z1 in the first direction Z. Portions of the tabs 512 of the coil bobbin 51 protruding from the bottom plate portion 21 to the side Z1 in the first direction Z are bent inward relative to the recesses 214, to fix the coil bobbin 51 to the base 20, as illustrated in FIG. 8.

Note that two grooves 216 are formed in the bottom face 210 of the base 20 from the hole 215 to the fixed terminals 26. Thus, both ends (not illustrated) of the coil 50 are led to the terminals 26 through the grooves 216 and are connected with the proximal ends of the terminals 26. In this state, the ends of the coil 50 are soldered to the terminals 26 to electrically connect the coil 50 and the terminals 26.

### Configuration of Movable Body 3

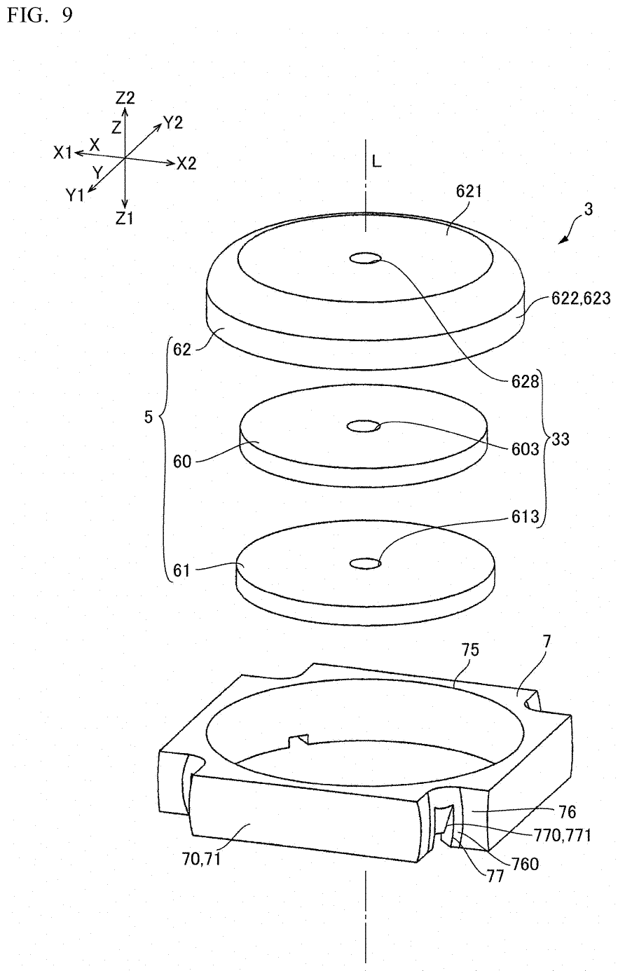

FIG. 9 is an exploded perspective view of the movable body 3 illustrated in FIG. 2. As illustrated in FIG. 3, FIG. 4, and FIG. 9, the movable body 3 includes a permanent magnet 60 disposed inside the coil 50, a first yoke 61 fixed to the permanent magnet 60 on the side Z1 in the first direction Z inside the coil 50, and a second yoke 62 fixed to the permanent magnet 60 on the side Z2 in the first direction Z. The permanent magnet 60 is magnetized in the first direction Z. The second yoke 62 includes a side plate portion 622 extending in a direction intersecting the first direction Z to a position facing the first yoke 61 across the coil 50. Thus, the permanent magnet 60, the first yoke 61, and the second yoke 62 form a magnetic field interlinked with the coil 50. That is, the permanent magnet 60, the first yoke 61, the second yoke 62, and the coil 50 constitute a magnetic drive circuit 5 that drives the movable body 3 in the direction Z relative to the support body 2.

In this embodiment, the side plate portion 622 constitutes a cylindrical body portion 623 that extends along the entire circumference around the axis L and faces the first yoke 61 across the coil 50. Since the coil 50 according to this embodiment has a cylindrical shape, the first yoke 61, the permanent magnet 60, and the plate portion 621 of the second yoke 62 fixed to the permanent magnet 60 each has a discoid shape, and the cylindrical body portion 623 of the side plate portion 622 has a cylindrical shape.

The movable body 3 according to this embodiment includes a holder 7 to which the outer face of the side plate portion 622 (cylindrical body portion 623) of the second yoke 62 is fixed. The holder 7 is composed of, for example, resin. The holder 7, which has a shape of a frame, has a hole 75 having a diameter that allows the cylindrical body portion 623 of the second yoke 62 to be fitted in the hole 75. Note that the outer edges of the holder 7 define a substantially square in view from the first direction Z. Thus, outer walls 70 of the holder 7 includes first flat faces 71 disposed on both sides in the second direction X intersecting the first direction Z and both sides in the third direction Y intersecting the first direction Z, regardless of the shapes of the coil 50, the first yoke 61, the permanent magnet 60, and the second yoke 62. In the movable body 3, holes 613, 603, 628 are formed at the centers of the first yoke 61, the permanent magnet 60, and the plate portion 621, respectively, of the second yoke 62. Consequently, a through-hole 33 is formed at the center of the movable body 3, penetrating the movable body 3 in the first direction Z.

### Configuration of Viscoelastic Members 4

In the support body 2 according to this embodiment, the inner faces of the support plates 25 illustrated in FIG. 5 constitute inner walls 201 on both sides in the second direction X and both sides in the third direction Y. The support plate 25 has a flat shape. Thus, the inner walls 201 of the support body 2 have second flat faces 251 at both sides in the second direction X and both sides in the third direction Y at positions facing the corresponding first flat faces 71 of the outer walls 70 of the holder 7. Hence, the viscoelastic members 4 are flat quadrangular members disposed between the first flat faces 71 and the second flat faces 251 on both sides in the second direction X and both sides in the third direction Y, and are in contact with both the first flat faces 71 and the second flat faces 251.

The viscoelastic members 4 are compressed in, for example, the thickness direction of the viscoelastic members 4. The viscoelastic members 4 adhere to the first flat faces 71 and the second flat faces 251 by the viscosity of the viscoelastic members 4. The viscoelastic members 4 may alternatively be adhered to the first flat faces 71 and the second flat faces 251 by an adhesive agent.

The viscoelastic members 4 are, for example, gelatinous members 40 (gelatinous damper members), such as silicone gel. The gelatinous members 40 have linear or non-linear stretching characteristics depending on the stretching direction. For example, the stretching characteristics of compressive deformation of the planar gelatinous members 40 in the thickness direction has a non-linear component larger than the linear component, whereas the stretching characteristics of elongation of the planar gelatinous members in the thickness direction has a linear component larger than the non-linear component. Also, in the case of deformation in a direction intersecting the thickness direction (shearing direction), the deformation characteristic has a linear component larger than the non-linear component. In this embodiment, the viscoelastic members 4 deform in the shear direction when the movable body 3 vibrates in the first direction Z. Thus, the viscoelastic members 4 deform within a range of high linearity, thereby achieving satisfactory linearity.

Positional Relation between Movable Body 3 and Viscoelastic Members 4

In the actuator 1 according to this embodiment, the center of gravity G of the movable body 3 and the center C4 of the viscoelastic members 4 in the first direction Z positionally coincide with each other in the first direction Z, as illustrated in FIG. 3 and FIG. 4. The movable body 3 has line symmetry about the center of an imaginary line extending through the axis L in the second direction X, and about the center of an imaginary line extending through the axis L in the third direction Y. Thus, the movable body 3 is rotationally symmetrical about the axis L.

### Configuration of Stopper Mechanisms 8

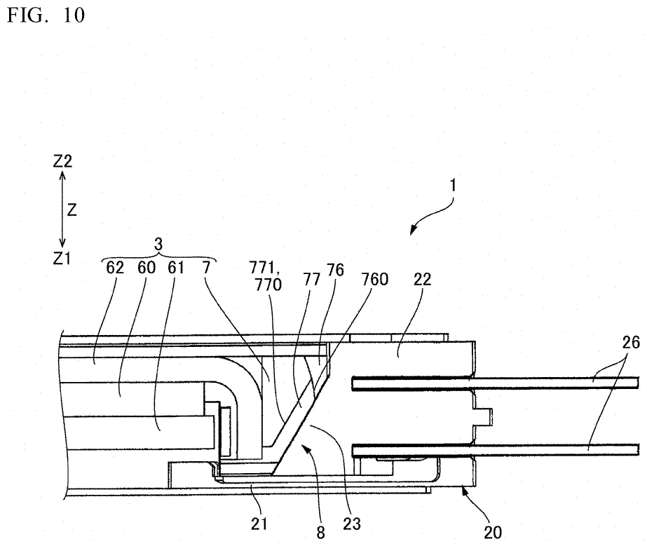

FIG. 10 illustrates a stopper mechanism 8 disposed between the support body 2 and the movable body 3 illustrated in FIG. 2, etc. As illustrated in FIG. 9 and FIG. 10, the four corners of the holder 7 have cutouts 76. The bottom portion of each of the cutouts 76 has a groove 77 having a bottom portion 771 or an inclined face 770 tilting relative to the side Z1 in the first direction Z. The groove 77 accommodates the corresponding triangular plate portion 23 of the base 20, which has been described with reference to FIG. 6, etc. Thus, the actuator 1 according to this embodiment includes stopper mechanisms 8 that restrict the movable range of the movable body 3 when the movable body 3 tilts by a large angle due to an external force. Each of the stopper mechanism 8 includes the bottom portion (inclined face 770) of the corresponding groove 77 of the holder 7 and the corresponding plate portion 23 of the base 20. More specifically, when the movable body 3 tilts by a large angle, the bottom portion 771 of each groove 77 of the holder 7 abut the corresponding plate portion 23 of the base 20. This restricts the movable range of the movable body 3 when the movable body 3 tilts.

In this embodiment, the portions of the outer walls 70 of the holder 7 disposed between adjacent first flat faces 71 around the axis L have convex faces curved along the first direction Z such that the movable body 3 does not abut the support body 2 before the bottom portions 771 of the grooves 77 of the holder 7 abut the plate portions 23 of the base 20. In this embodiment, the bottom faces 760 of the cutouts 76 are convex faces curving along the first direction Z. Thus, the columnar portions 22 of the base 20 do not come into contact with the inner faces of the cutouts 76 of the holder 7 before operation of the stopper mechanism 8.

### Basic Action

Applying an alternating current to the coil 50 of the actuator 1 according to this embodiment causes the movable body 3 to vibrate in the first direction Z. This causes the center of gravity of the actuator 1 to shift in the first direction Z. Thus, the user who holds the actuator 1 can feel the vibration in the first direction Z. At this time, the AC waveform applied to the coil 50 can be adjusted to cause a difference between the acceleration of the movable body 3 moving to the side Z1 in the first direction Z and the acceleration of the movable body 3 moving to the side Z2 in the first direction Z. In this way, the user can feel vibration having directionality in the first direction Z.

### Panel Speaker 100

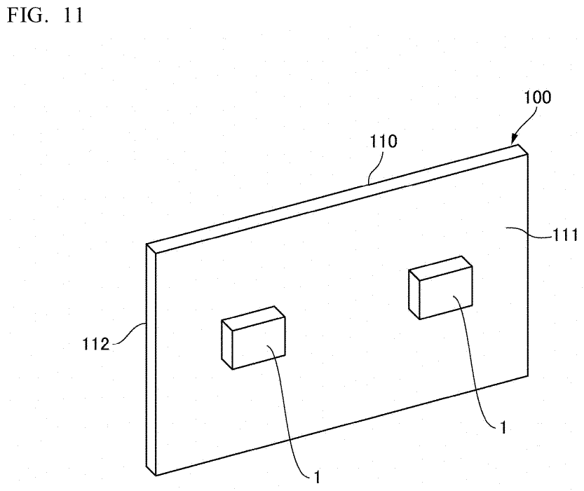

FIG. 11 illustrates a panel speaker 100 including the actuators 1 illustrated in FIG. 1. As illustrated in FIG. 11, a panel speaker 100 is structured such that end portions in the first direction Z of support bodies 2 of actuators 1 are fixed to the back face 111 of a panel member 110. In the panel speaker 100, application of an alternating current to the coils 50 of the actuators 1 causes the movable bodies 3 to vibrate in the first direction Z, thereby causing the reaction force to be transmitted to the panel member 110. Thus, the vibration of the panel member 110 causes sound corresponding to the alternating current applied to the coils 50 to be generated from the front face 112 of the panel member 110. The panel member 110, which is an organic electroluminescent display panel or the like, emits sound corresponding to the displayed images from the panel member 110.

FIG. 11 illustrates an embodiment in which two actuators 1 are disposed on the panel member 110. Alternatively, two or more actuators 1 may be disposed depending on the magnitude of the sound to be outputted.

### Major Advantageous Effects of This Embodiment

As described above, the movable body 3 of the actuator 1 according to this embodiment includes the holder 7 to which the outer face of the side plate portion 622 (cylindrical body portion 623) of the second yoke 62 is fixed. Thus, the viscoelastic members 4 can be disposed between the first flat faces 71 of the outer walls 70 of the holder 7 and the second flat faces 251 of the inner walls 201 of the support body 2, regardless of the shapes of the coil 50 and the second yoke 62. For example, even in the case where the coil 50 has a cylindrical shape and the cylindrical body portion 623 of the second yoke 62 has a cylindrical shape, the viscoelastic members 4 can be disposed between the first flat faces 71 of the outer walls 70 of the holder 7 and the second flat faces 251 of the inner walls 201 of the support body 2. Hence, the viscoelastic members 4 may be flat members. This achieves advantageous effects such as ready handling of the viscoelastic members 4 during assembling of the actuator 1.

The center of gravity G of the movable body 3 and the center C4 of the viscoelastic members 4 in the first direction Z positionally coincide with each other in the first direction Z. This leads to an advantage in that the movable body 3 does not readily tilt.

The holes 603, 613, and 628 respectively formed in the first yoke 61, the permanent magnet 60, and the second yoke 62 constitute the through-hole 33 penetrating the movable body 3 at the center of the movable body 3 in the first direction Z. Thus, the first yoke 61, the permanent magnet 60, and the second yoke 62 can be aligned by an alignment pin passed through the through-hole 33 during assembly of the actuator 1. The through-hole 33 functions as an air vent hole while the movable body 3 vibrates in the first direction Z. Thus, the movable body 3 can smoothly vibrate.

In the panel speaker 100 according to this embodiment including the actuators 1 fixed to the back face 111 of the panel member 110, the reaction force generated during vibration of the movable body 3 in the first direction Z is transmitted to the panel member 110, causing sound to be emitted from the front face 112 of the panel member 110. Since no chassis or the like is required for fixing the actuator 1 to the back face 111 of the panel member 110, the panel speaker 100 can have a small thickness.

### Other Embodiments

In the actuator 1 according to the above-described embodiment, for example, a viscoelastic member 4 may be further disposed on the side Z1 in the first direction Z such that the center of the first yoke 61 in the first direction Z and the center of the viscoelastic member 4 in the first direction Z positionally coincide with each other in the first direction Z. Such an embodiment is advantageous in that the movable body 3 does not readily tilt during driving of the movable body 3. In another embodiment, the center of the first yoke 61 in the first direction Z, the center of the viscoelastic member 4 in the first direction Z, and the center of gravity of the movable body 3 may positionally coincide with each other in the first direction Z. Such an embodiment is advantageous in that the movable body 3 does not readily tilt further during driving of the movable body 3.

In the above-described embodiment, the side plate portion 622 of the second yoke 62 constitutes the cylindrical body portion 623. Alternatively, at least an embodiment of the present invention may be applied to a prismatic or a side plate portion 622 not constituting a cylindrical body portion 623.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An actuator comprising:
a support body that holds a cylindrical coil wound around an axis extending in a first direction; and
a movable body supported by the support body via a viscoelastic member,
wherein the movable body comprises:
a permanent magnet magnetized in the first direction;
a first yoke fixed to a first side of the permanent magnet in the first direction inside the coil;
a second yoke fixed to a second side of the permanent magnet in the first direction and comprising a side plate portion extending to a position facing the first yoke across the coil in a direction intersecting the first direction; and
a holder to which an outer face of the side plate portion is fixed,
wherein an outer wall of the holder comprises first flat faces on both sides in a second direction intersecting the first direction,
wherein an inner wall of the support body comprises second flat faces facing the first flat faces on both sides in the second direction, and
wherein the viscoelastic member comprises flat members disposed between the first flat faces and the corresponding second flat faces on both sides in the second direction.

2. The actuator according to claim 1, wherein the side plate portion comprises a cylindrical body portion facing the first yoke across the coil along an entire circumference around the axis.

3. The actuator according to claim 2, wherein,
the coil has a cylindrical shape,
the first yoke, the permanent magnet, and a plate portion of the second yoke fixed to the permanent magnet have discoid shapes, and
the cylindrical body portion has a cylindrical shape.

4. The actuator according to claim 2, wherein,
the outer wall of the holder further comprises the first flat faces on both sides in a third direction intersecting the first direction and the second direction,
the inner wall of the support body further comprises the second flat faces facing the first flat faces on both sides in the third direction, and
the viscoelastic member comprises flat members disposed between the first flat faces and the corresponding second flat faces on both sides in the second direction and both sides in the third direction.

5. The actuator according to claim 4, wherein a portion of the outer wall disposed between the first flat faces adjacent to each other around the axis comprises a convex face curved along the first direction and protruding toward the support body.

6. The actuator according to claim 1, wherein a center of gravity of the movable body and a center of the viscoelastic member in the first direction positionally coincide with each other in the first direction.

7. The actuator according to claim 1, wherein a center of the first yoke in the first direction and a center of the viscoelastic member in the first direction positionally coincide with each other in the first direction.

8. The actuator according to claim 1, wherein a center of the first yoke in the first direction, a center of the viscoelastic member in the first direction, and a center of gravity of the movable body positionally coincide with each other in the first direction.

9. The actuator according to claim 1, wherein a through-hole penetrates the movable body at a center of the movable body in the first direction.

10. A panel speaker comprising an actuator, comprising:
a support body that holds a cylindrical coil wound around an axis extending in a first direction; and
a movable body supported by the support body via a viscoelastic member;
wherein the movable body comprises:
a permanent magnet magnetized in the first direction;
a first yoke fixed to one side of the permanent magnet in the first direction inside the coil;
a second yoke fixed to another side of the permanent magnet in the first direction and comprising a side plate portion extending to a position facing the first yoke across the coil in a direction intersecting the first direction; and
a holder to which an outer face of the side plate portion is fixed,
wherein an outer wall of the holder comprises first flat faces on both sides in a second direction intersecting the first direction,
wherein an inner wall of the support body comprises second flat faces facing the first flat faces on both sides in the second direction,
wherein the viscoelastic member comprises flat members disposed between the first flat faces and the corresponding second flat faces on both sides in the second direction, and
wherein an end on one side of the support body in the first direction being fixed to a panel member.

11. The panel speaker according to claim 10, wherein the panel member comprises a display panel.

12. The actuator according to claim 5, wherein a center of gravity of the movable body and a center of the viscoelastic member in the first direction positionally coincide with each other in the first direction.

13. The actuator according to claim 5, wherein a center of the first yoke in the first direction and a center of the viscoelastic member in the first direction positionally coincide with each other in the first direction.

14. The actuator according to claim 5, wherein a center of the first yoke in the first direction, a center of the viscoelastic member in the first direction, and a center of gravity of the movable body positionally coincide with each other in the first direction.

15. The actuator according to claim 5, wherein a through-hole penetrates the movable body at a center of the movable body in the first direction.

16. The actuator according to claim 3, wherein,
the outer wall of the holder further comprises the first flat faces on both sides in a third direction intersecting the first direction and the second direction,
the inner wall of the support body further comprises the second flat faces facing the first flat faces on both sides in the third direction, and
the viscoelastic member comprises flat members disposed between the first flat faces and the corresponding second flat faces on both sides in the second direction and both sides in the third direction.

17. The actuator according to claim 16, wherein a portion of the outer wall disposed between the first flat faces adjacent to each other around the axis comprises a convex face curved along the first direction and protruding toward the support body.

18. The actuator according to claim 17, wherein a center of gravity of the movable body and a center of the viscoelastic member in the first direction positionally coincide with each other in the first direction.

19. The actuator according to claim 17, wherein a center of the first yoke in the first direction and a center of the viscoelastic member in the first direction positionally coincide with each other in the first direction.

20. The actuator according to claim 17, wherein a center of the first yoke in the first direction, a center of the viscoelastic member in the first direction, and a center of gravity of the movable body positionally coincide with each other in the first direction.
